(19) United States
(12) Patent Application Publication
(10) Pub. No.: US 2011/0253613 A1
(43) Pub. Date: Oct. 20, 2011

(54) CONTAMINANT REMOVAL SYSTEM UTILIZING DISC FILTER

(75) Inventors: Darin L. St. Germain, Gilbert, IA (US); Leslie Uhlmeyer, Ames, IA (US); Daniel L. Willers, Des Moines, IA (US); Eric A. Lawrence, Madrid, IA (US); Joseph E. Zuback, Camarillo, CA (US)

(73) Assignee: SIEMENS INDUSTRY, INC., Alpharetta, GA (US)

(21) Appl. No.: 13/097,771

(22) Filed: Apr. 29, 2011

Related U.S. Application Data
(63) Continuation-in-part of application No. 12/613,454, filed on Nov. 5, 2009.
Application No. 12/613,454 is a continuation of application No. 11/428,635, filed on Jul. 5, 2006, now Pat. No. 7,670,486.
(60) Provisional application No. 60/696,846, filed on Jul. 6, 2005.

(51) Int. Cl. C02F 1/52; C02F 1/58

(52) U.S. Cl. 210/195.3

(57) ABSTRACT

A system is adapted to remove one or more contaminants, particularly phosphorus, from an influent. The system includes a first section receiving the influent and discharging a first flow. A first coagulant inlet is positioned upstream of the first section and is in fluid communication with the influent to introduce a first coagulant selected to precipitate the contaminant. A second section receives the first flow and discharges a second flow, and a third section including a disc filter receives the second flow and discharges an effluent. A second coagulant inlet is positioned downstream of the first section and upstream of the third section to introduce a second coagulant selected to precipitate the contaminant.

### CROSS REFERENCE TO RELATED APPLICATIONS

This application is a continuation-in-part of U.S. patent application Ser. No. 12/613,454, filed 5 Nov. 2009, which is a continuation of U.S. patent application Ser. No. 11/428,635, filed 5 Jul. 2006, which claims benefit of priority under 35 USC 119(e) to U.S. Provisional Patent Application No. 60/686,550, filed on 6 Jul. 2005, the entire contents and substance of which are hereby incorporated by reference as if fully set forth below.

### BACKGROUND

Embodiments of the present invention relate to a system and method for removing contaminants from an influent and, more particularly, to a system and method for removing phosphorus from an influent using a multi-stage treatment system.

Influent, such as contaminated water, is often treated using a multi-stage process to allow for the removal of various contaminates. The treatment processes may include coagulation, absorption, adsorption, filtration, biological treatment, and/or chemical treatment. But contaminants, particularly phosphorus, can be difficult to remove because it may be present in different forms such as soluble phosphorus, polyphosphate, and phosphorus tied to bacteria or other organic material. In addition, some particulate phosphorus may be too small for filtration or coagulation to be effective. Conventional systems cannot reduce the level of phosphorus in an influent below about 50 parts per billion (ppb).

Further, current systems use a granular media filter which is integral to a two stage clarifier. Such configurations require a separate backwash storage tank and backwash supply pumping system that adds to complexity and construction and installation costs.

### SUMMARY

Briefly described, embodiments of the present invention relate to a system for removing at least one contaminant from an influent.

In one aspect, the system is adapted to remove one or more contaminants, including phosphorus, from an influent. The system includes a first section receiving the influent and discharging a first flow. A first coagulant inlet is positioned upstream of the first section and is in fluid communication with the influent to introduce a first coagulant selected to precipitate the contaminant. A second section receives the first flow and discharges a second flow, and a third section including a disc filter receives the second flow and discharges an effluent. A second coagulant inlet is positioned downstream of the first section and upstream of the third section to introduce a second coagulant selected to precipitate the contaminant.

In an exemplary embodiment, the system comprises: a first section comprising a tube section, the first section receiving the influent, dividing the influent into a first flow and a sludge, and discharging the first flow; a first coagulant inlet positioned upstream of the first section and in fluid communication with the influent to introduce a first coagulant for precipitating the contaminant; a second section comprising an adsorption clarifier, the second section receiving the first flow and discharging a second flow; a third section comprising a disc filter, the third section receiving the second flow and discharging an effluent; a second coagulant inlet positioned downstream of the first section and upstream of the third section to introduce a second coagulant for precipitating the contaminant; a first return line connecting the sludge to a position upstream of, and in fluid communication with, the first section, wherein a portion of the sludge is pumped via the first return line to a position upstream of the first section, and wherein a portion of the sludge is mixed with the influent; and at least one additional return line connecting a position downstream of the first section, to a position upstream of, and in fluid communication with, the first section, wherein a portion of contaminates from the position downstream of the first section is pumped via the additional return line to a position upstream of the first section, and wherein a portion of the contaminates is mixed with the influent, wherein a third coagulant is introduced into the first return line before the portion of sludge is mixed with the influent.

Other aspects of the invention will become apparent by consideration of the detailed description and accompanying drawings.

### BRIEF DESCRIPTION OF THE DRAWINGS

FIG. 1 is a schematic illustration of a multi-stage treatment system during normal operation, in accordance with an exemplary embodiment of the present invention.

FIG. 2 is a schematic illustration of the multi-stage treatment system of FIG. 1 during a rinse of a second stage and a backwash of a third stage, in accordance with an exemplary embodiment of the present invention.

FIG. 3 is a partial cross-sectional, side view of a disc filter including a plurality of filter panels, in accordance with an exemplary embodiment of the present invention.

FIG. 4 is a cross-sectional, side view of the disc filter of FIG. 3, in accordance with an exemplary embodiment of the present invention.

FIG. 5 is a perspective view of a drum of the disc filter of FIG. 3, in accordance with an exemplary embodiment of the present invention.

FIG. 6 is a side view of a portion of the disc filter of FIG. 3, in accordance with an exemplary embodiment of the present invention.

FIG. 7 is another view of a portion of the disc filter of FIG. 3, in accordance with an exemplary embodiment of the present invention.

FIG. 8 is a cross-sectional view of a portion of a disc of the disc filter of FIG. 3, in accordance with an exemplary embodiment of the present invention.

FIG. 9 is a front view of a filter panel in a support frame attached to the drum of the disc filter of FIG. 3, in accordance with an exemplary embodiment of the present invention.

FIG. 10 is a perspective view of the filter panel of FIG. 9, in accordance with an exemplary embodiment of the present invention.

FIG. 11 is a front view of the filter panel of FIG. 9, in accordance with an exemplary embodiment of the present invention.

FIG. 12 is a schematic view of the backwash spray bar arrangement, in accordance with an exemplary embodiment of the present invention.

FIG. 13 is a schematic view of a backwash nozzle arrangement disposed between two adjacent discs of the disc filter of FIG. 3, in accordance with an exemplary embodiment of the present invention.

FIG. 14 depicts a filter support positioned on a drum, in accordance with an exemplary embodiment of the present invention.

FIG. 15 depicts a top view of a tube clarifier, adsorption clarifier and disc filter located in a tank, in accordance with an exemplary embodiment of the present invention.

FIG. 16 depicts a side view of the tank shown in FIG. 15, in accordance with an exemplary embodiment of the present invention.

### DETAILED DESCRIPTION

To facilitate an understanding of the principles and features of the invention, embodiments are explained hereinafter with reference to implementation in an illustrative embodiment. In particular, embodiments of the invention are described in the context of being a system for removing contaminants.

The phraseology and terminology used herein is for the purpose of description and should not be regarded as limiting. Herein, the use of terms such as “including” or “includes” is open-ended and is intended to have the same meaning as terms such as “comprising” or “comprises” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

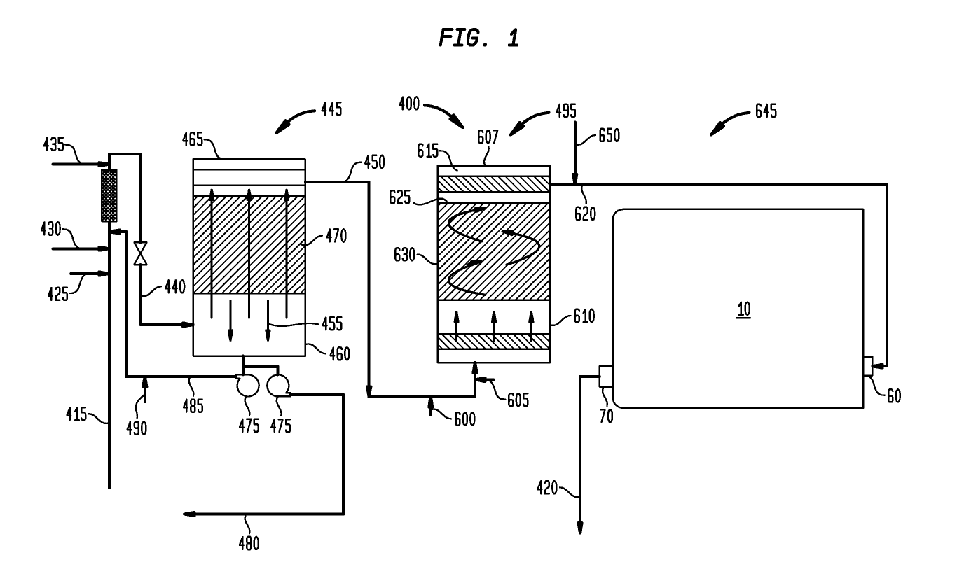

FIG. 1 is a schematic illustration of a multi-stage treatment system 400 that is capable of treating an influent 415 to produce an effluent 420 having desired properties (e.g., desired contaminant levels, turbidity, etc.). Systems similar to the one illustrated are sold by Siemens and/or one of its affiliates as TRIDENT water treatment systems. The illustrated treatment system 400 includes three stages of treatment, with other systems including more or fewer stages. For example, many systems 400 employ a settling stage in which the influent 415 is allowed to settle for a predetermined period of time before it is directed into the three illustrated stages. Other systems may include ozone treatment or still other treatments, in addition to those discussed herein. As such, embodiments of the present invention are not limited to three-stage systems, nor are they limited to the three particular stages described herein.

In operation, influent 415 enters the illustrated three-stage system 400 via a pipe, conduit, or other flow path. Chemicals 425 can be added to the influent 415 to adjust the pH and the alkalinity of the flow before further treatment. In addition, a first coagulant 430 and a first polymer 435 are added to the influent 415 to define a first flow 440 that then enters the three stage system 400.

The first flow 440 enters a first stage 445 of the multi-stage treatment system 400. In an exemplary embodiment, the first stage 445 includes a lamella, or tube section that functions to separate the first flow 440 into a second flow 450 and a sludge 455. The tube section 445 includes a bottom portion 460, a top portion 465, and a plurality of substantially vertically oriented tubes 470 that extend between the bottom portion 460 and the top portion 465. The first flow 440 enters the tube section 445 at the bottom portion 460 and the second flow 450 exits the tube section 445 from the top portion 465.

The first polymer 435 can act as a flocculent to collect contaminates within the first flow 440 and form larger heavier particles of contaminates (floc). Similarly, the first coagulant 430 collects contaminates and forms larger, heavier particles. The first coagulant 430 can be selected from a number of available metal salts, for example and not limitation aluminum-based salts (e.g., alum, etc.) and iron-based salts (e.g., ferric chloride, ferric sulfate, ferrous sulfate, etc.). The metal salts aid in precipitating contaminants, including phosphorus, from the first flow 440. Accordingly, the first coagulant 430 can reduce the amount of phosphorus and other contaminants in the first flow 440 as it passes through the tube section 445.

In the tube section 445, the larger, heavier particles do not flow upward through the tubes 470 with the second flow 450, but rather fall downward and collect on the bottom to form the sludge 455. One or more pumps 475 are positioned to draw sludge 455 from the tube section 445 and pump the sludge 455 to waste 480. In some embodiments, the pumps 475 operate continuously to draw the sludge 455 from the tube section 445, with other embodiments employing intermittent pump operation. In an exemplary embodiment, a portion of the sludge 485 can be pumped into the influent 415 or first flow 440, via a first return line, before the first flow 440 enters the tube section 445. This allows the first coagulant 430 or first polymer 435 that remains active within the sludge 485 to collect additional contaminates, thus reducing the quantity of first coagulant 430 and first polymer 435 required.

In some embodiments, a second coagulant 490 can be added to the flow of sludge 485 before it enters the influent 415 or first flow 440. The additional coagulant 490 can further improve the reduction of contaminates in the second flow 450. Typically, the same metal salt is employed as the second coagulant 490, as was employed as the first coagulant 430. But other systems may employ a different coagulant, or multiple coagulants (e.g., alum in combination with ferric chloride) if desired.

The second flow 450 exits the tube section 445 and flows into a second section 495 of the multi-stage treatment system 400. In some embodiments, a third coagulant 600 can be added to the second flow 450 before it enters the second section 495. In an exemplary embodiment, the third coagulant 600 can include the same metal salt used as the first coagulant 430 and/or the second coagulant 490, with other coagulants also being suitable for use. An additional polymer 605 can also be added before the second flow 450 enters the second stage 495. Like the coagulant 600, some embodiments employ the same polymer 605 that was used as the first polymer 435. But other polymers may be employed as desired.

The second section 495 of the multi-stage treatment system 400 includes an adsorption clarifier 607 having a bottom portion 610 and a top portion 615. The second flow 450 enters the adsorption clarifier 607 near the bottom 610 and flows upward to the top portion 615. A third flow 620 exits the adsorption clarifier 607 from the top portion 615. The tube section 445 and the adsorption clarifier 607 may be arranged in a stacked configuration. Alternatively, the tube section 445 and the adsorption clarifier 607 may be arranged in a side-by-side configuration.

In an exemplary arrangement of the adsorption clarifier 607, a media retainer 625, such as a screen, holds a buoyant adsorption media 630 in place. The second flow 450 flows upward through the adsorption media 630, which adsorbs unwanted contaminates as the flow passes.

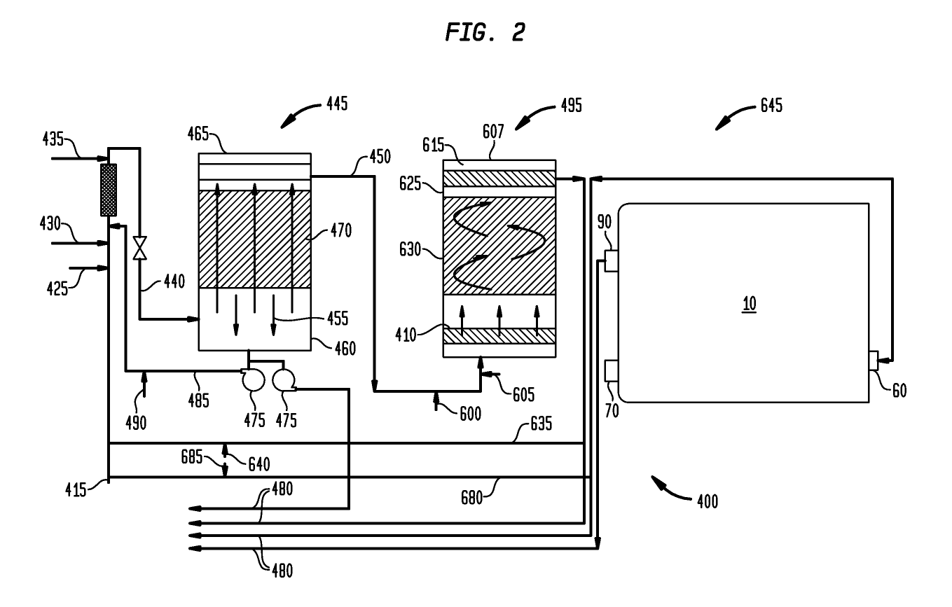

Periodically, the adsorption clarifier 607 must be flushed (see, e.g., FIG. 2) to collect the unwanted contaminates that have been adsorbed by the adsorption media 630. The collected contaminates are directed to waste 480. A portion of the collected contaminates 635 may be directed to the influent 415 or first flow 440 via a second return line. In some embodiments, a fourth coagulant 640 can be added to the flow 635 within the second return line before the flow 635 enters the influent 415 or the first flow 440. As with the other coagulants, the fourth coagulant 640 can be a metal salt, and may be the same metal salt as is used as the first coagulant 430, the second coagulant 490, and/or the third coagulant 600.

The third flow 620 passes out of the adsorption clarifier 607 near the top portion 615 and enters a third section 645 of the multi-stage treatment system 10. In some embodiments, a fifth coagulant 650 can be added to the third flow 620 before the third flow 620 enters the third section 645. As with prior coagulants, exemplary embodiments employ the same coagulant for the fifth coagulant 650 as is employed as the first coagulant 430, the second coagulant 490, the third coagulant 600, and/or the fourth coagulant 640, with other coagulants also being possible.

In an exemplary embodiment, the third section 645 can include a disc filter 10 wherein final solids removal occurs. The disc filter 10 may be of the type having a plurality of discs each including a plurality of filter segments. Each filter segment includes a pair of filter panels that are arranged to form a pocket for receiving water. Each filter panel includes filter media, such as finely woven cloth for filtering water. One such disc filter is the Forty-X™ disc filter manufactured by Siemens although other disc filters may be used.

It should be noted that the teachings apply not only to disc filters, but also may be adapted to drum type and other type filters that are used to filter high volume, high solids content fluids. The teachings apply not only to “inside-out” type filters using liquid head difference as a filtration driving force, but also apply to vacuum type filters, including “outside-in” type filters, and filters that operate in an enclosed vessel under pressure. Such type filters are exemplified and described in more detail in the brochures titled REX MICROSCREENS published by Envirex and dated August 1989, REX Rotary Drum Vacuum Filters published by Envirex, and REX MICROSCREENS Solids Removal For Lagoon Upgrading, Effluent Polishing, Combined Sewer Overflows, Water Treatment, Industrial Wastewater Treatment and Product Recovery published by Envirex in 1989 which are hereby incorporated herein by reference in their entirely.

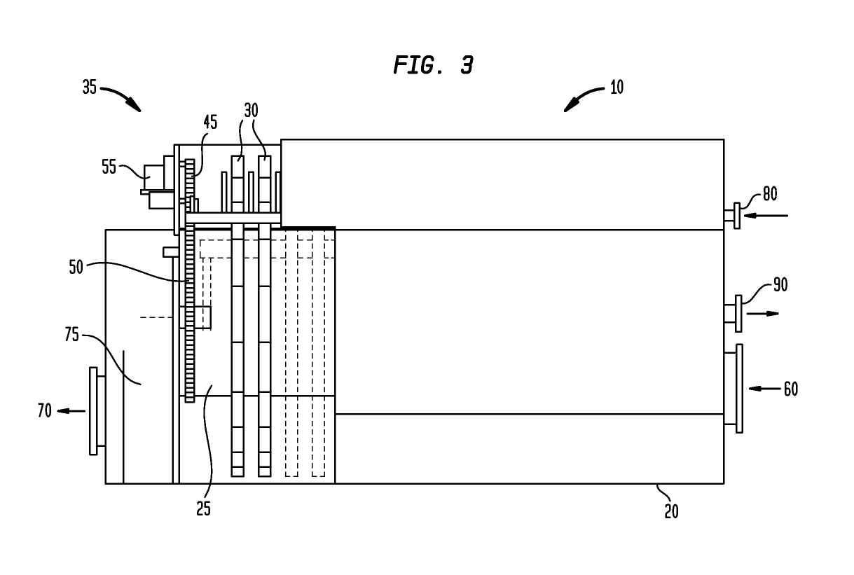

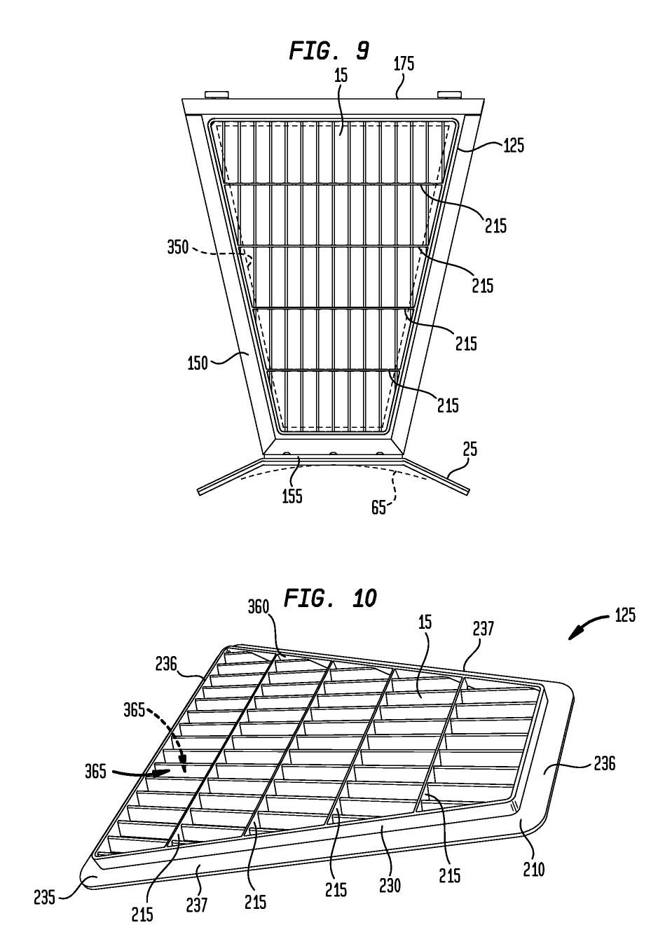

FIG. 3 illustrates a possible disc filter system configuration 10 employing pleated filter media 15 (FIG. 9). The media 15 may be woven or non-woven. In addition, pile cloth, needle felt, microfiltration, nanofiltration, reverse osmosis, or other membranes may be employed as media constructions. Materials for use in making filter media include but are not limited to polyester, metal-coated polyester, antimicrobial-coated polyester, polypropylene, nylon, stainless steel wire, glass fiber, alumina fiber, glass filled polypropylene (17% preferred), glass-filled acetal, and/or glass-filled nylon.

The term “filter media” should be interpreted broadly to cover components that filter a fluid. Other terms included within the definition of filter media include membrane, element, filter device, and the like. As such, the term “filter media” should not be narrowly interpreted to exclude components that filter fluid.

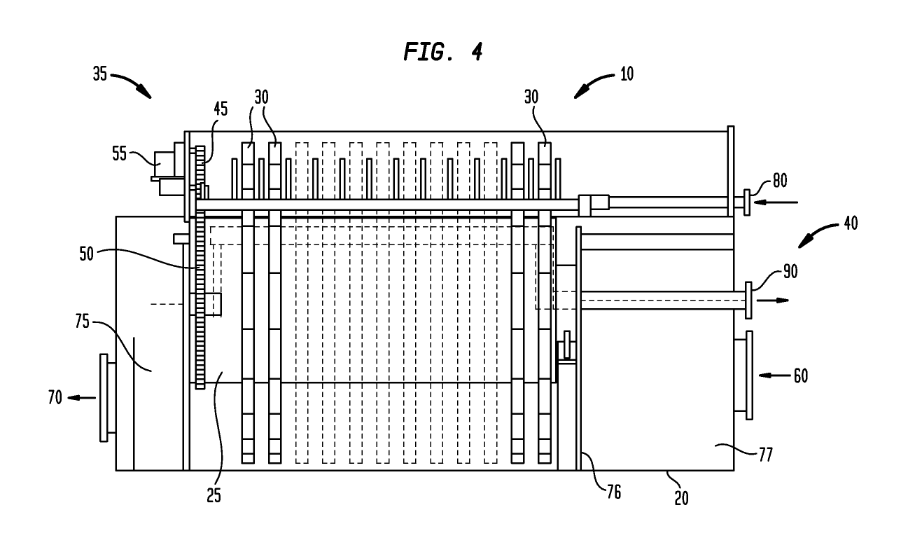

Referring to FIGS. 3 and 4, the disc filter 10 includes a housing 20, such as a metal tank that substantially encloses a drum 25, a plurality of discs 30, a drive system 35, and a flow system 40. Variations on this design, including those employing a frame intended to facilitate mounting of the unit in a concrete tank can also be implemented. The drive system 35 can include at least two bearings that support the drum 25 for rotation. A driven sprocket 50 is coupled to the drum 25 and a drive sprocket 45 is coupled to a motor 55 or other prime mover. In an exemplary embodiment, a belt can engage the drive sprocket 45 and the driven sprocket 50, such that rotation of the motor 55 produces a corresponding rotation of the drum 25. In some embodiments, the sprockets 45, 50 are sized to produce a significant speed reduction. But some embodiments may employ a slow speed drive with no speed reduction if desired. While an exemplary embodiment employs a belt drive, other embodiments may employ gears, shafts, chains, direct drive, or other means for transferring the rotation of the motor 55 to the drum 25.

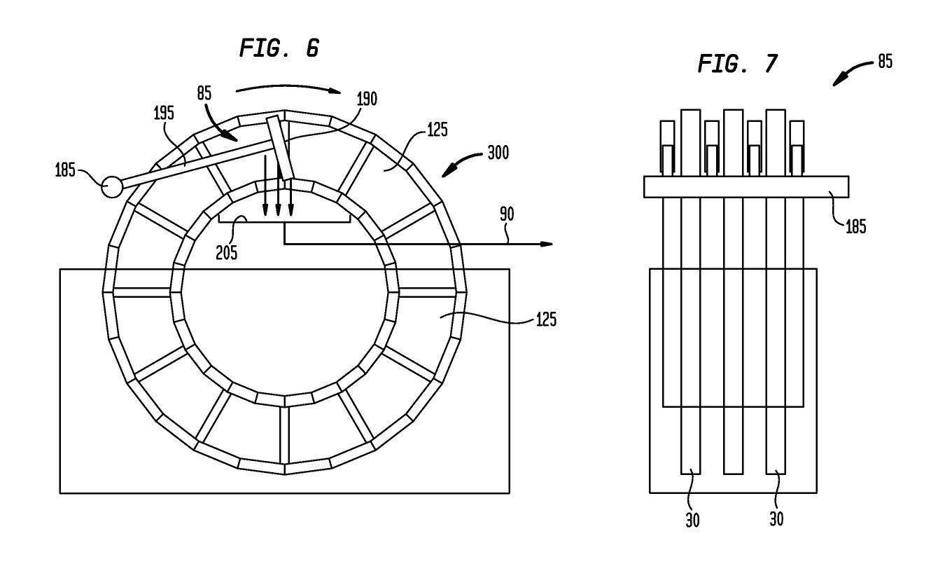

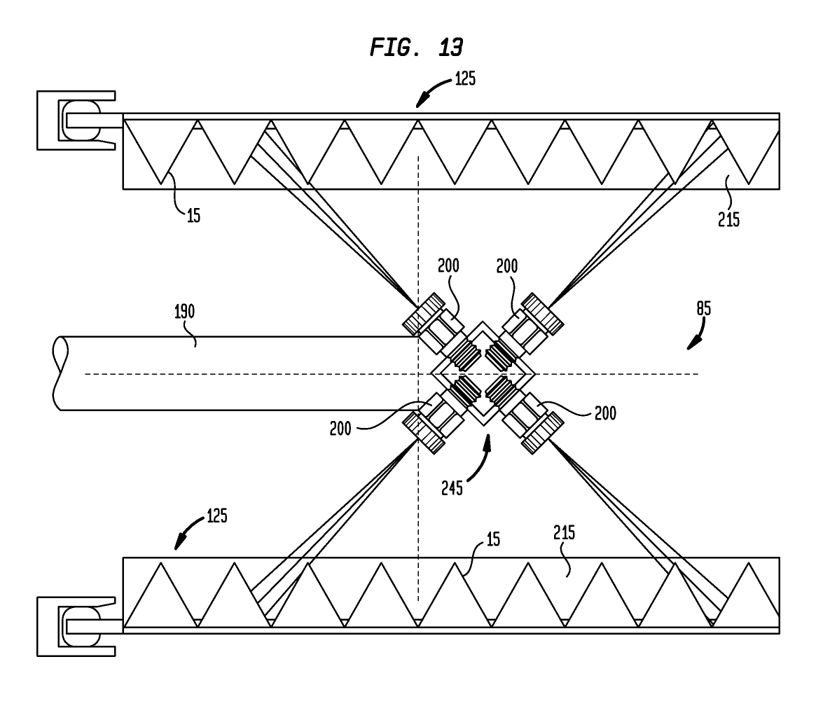

The flow system 40, generally illustrated in FIG. 4, includes an influent pipe 60 that directs influent (third flow 620) into an interior 65 (see FIG. 9) of the drum 25, an effluent pipe 70 that directs filtered fluid from a chamber 75 defined within the housing 20 out of the filter 10. A spray water pipe 80 can provide high-pressure water to a spray system 85 (see FIGS. 6 and 13) that is periodically used to clean the filter media 15. A backwash pipe 90 transports the spray water after use and directs it out of the disc filter 10.

The disc filter 10 of FIGS. 3 and 4 employs a plurality of discs 30 to increase the overall filter area. The number and size of the discs 30 can be varied depending on the flow requirements of the system. For example and not limitation, additional discs 30 can be attached to the drum 25 to increase the capacity of the filter system 10 without having to pass additional flow through the already existing discs 30.

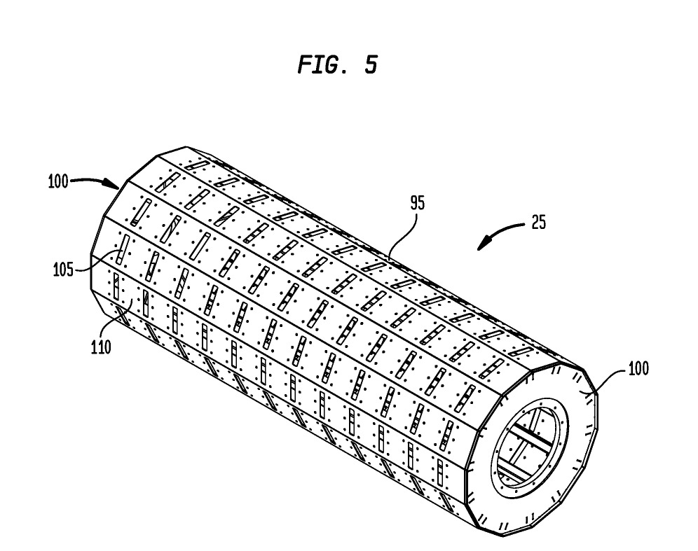

FIG. 5 illustrates an exemplary drum configuration 25 that is suitable for use with embodiments of the present invention. The illustrated drum 25 includes an outer surface 95 and two end surfaces 100 that cooperate to define the interior space 65. One end is open to permit flow and the other end is sealed against flow. Several drum apertures 105 are arranged in a series of axial rows with each row including a number of drum apertures 105 that extend circumferentially around a portion of the outer surface 95. As illustrated, the drum apertures 105 are rectangular, although other shapes may be suitable. Attachment apertures 110 are positioned on either side of each drum aperture 105. Each drum aperture 105 is associated with a set of attachment apertures 110.

Referring to FIG. 6, a side view of one of the discs 30 of FIGS. 3 and 4 is shown. Each disc 30 includes a plurality of filter panel sets 300. Each filter panel set 300 includes two associated filter panels 125. In FIG. 9, one of the filter panels 125 from each panel set 300 is shown. The disc 30 in FIG. 6 depicts twelve filter panels 125 and thus disc 30 includes a total of twenty four filter panels 125. But other embodiments may employ more or fewer filter panels 125 as desired. For example, twenty eight filter panels 125 may be used (i.e., 14 filter panel sets).

Referring to FIG. 8, one of the filter panel sets 300 is depicted. FIG. 8 is a side view of FIG. 9 with a right portion of a support structure 150 (see FIG. 9) removed. The filter panels 125 are mounted in the support structure 150 such that the filter panels are spaced apart from each other. An attachment plate 155 having an aperture 145 engages the attachment apertures 110 around a drum aperture 105 to attach the support structure 150 to the drum 25. A cap 175 is located over a top portion of the filter panels 125. The filter panels 125, the support structure 150 in which they are mounted, the cap 175, and the attachment plate 155 define a partially enclosed space 180. The partially enclosed space 180 extends circumferentially around the drum 25 through each filter panel set 300 on the disc 30. Fluid is able to pass from within the drum 25, through the drum aperture 105 and aperture 145 in the attachment plate 155 and into the enclosed space 180 to enable fluid to flow circumferentially within each filter panel set in the disc 30, as will be discussed below. A perimeter seal 165 is located on a perimeter 170 of each filter panel 125 and serves to inhibit leakage of water from around the filter panel 125.

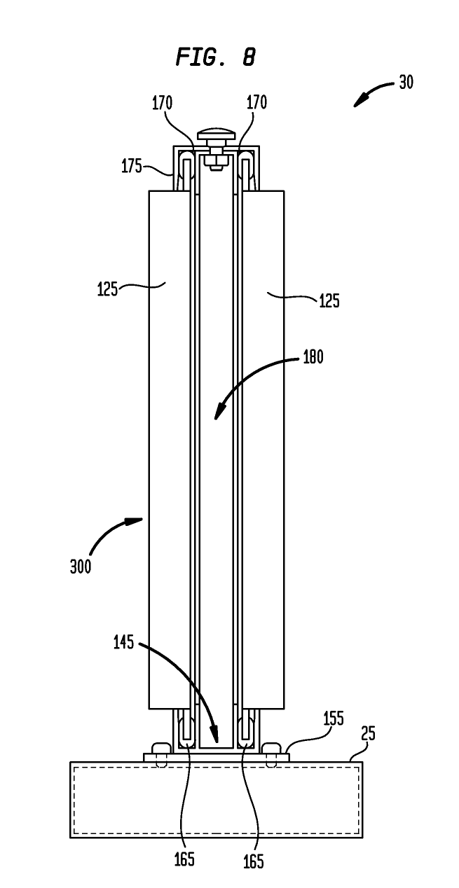

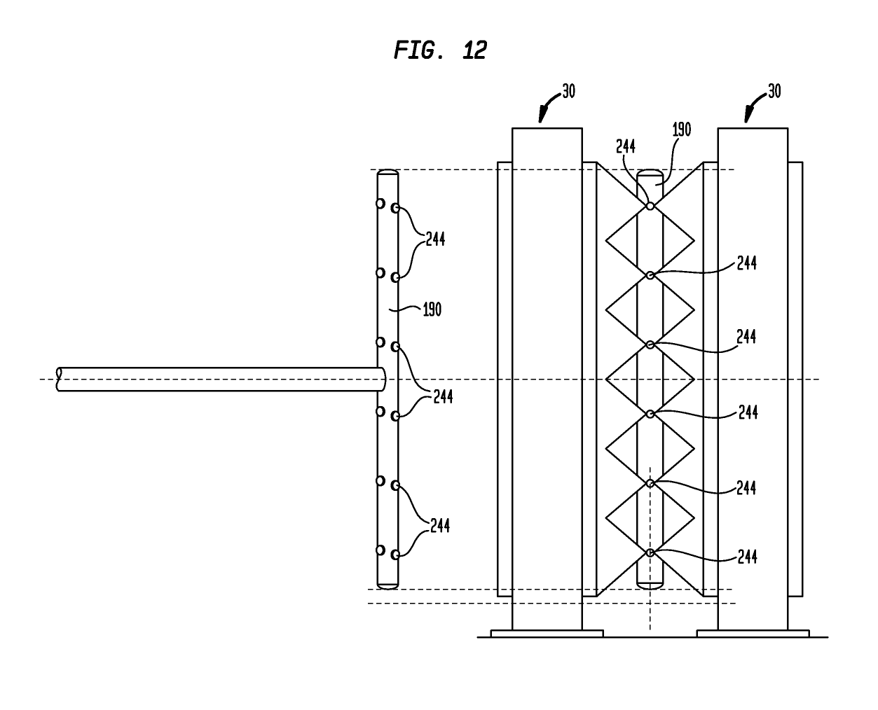

Referring to FIG. 4 in conjunction with FIGS. 6 and 7, the spray water pipe 80 extends the full length of the disc filter 10 and defines a distribution manifold 185. A spray bar 190 can be positioned between adjacent discs 30 (see FIG. 12) and at each end of the disc filter 10. A distribution pipe 195 extends between the manifold 185 and the spray bar 190 to provide for fluid communication of high-pressure water to the spray bar 190. The spray bar 190 includes nozzles 200 that spray water onto the filter panels 125 to periodically clean the filter panels 125 as will be described in greater detail with reference to FIGS. 12 and 13.

A trough 205 can be positioned beneath the spray bar 190 between adjacent discs 30 to catch the spray water or backwash, including particulate matter removed from the filter panels 125. The backwash and particles are then removed from the system 10 via the backwash pipe 90.

FIGS. 9 and 10 illustrate possible arrangements of the filter panels 125. FIG. 9 illustrates the panel 125 mounted in the support structure 150 (see also FIG. 4). FIG. 10 illustrates a pleated panel. The filter panels 125 include a pleated filter media 15, a perimeter frame 210, and several support gussets or stringers 215. In some embodiments, the stringers 215 are molded as an integral part of the frame 210 with other attachment means also being suitable for use. In an exemplary embodiment, the pleated filter media 15 is formed from a single piece of material that is sized and shaped to fit within the perimeter frame 210. As generally illustrated, the pleats extend in a substantially radial direction with other orientations also being possible. In one embodiment, a stainless steel screen is employed as the filter media 15. Other embodiments may employ woven polyester, cloth, or other materials. The materials used and the size of the openings are chosen based on the likely contaminates in the effluent, the flow rate of the effluent, as well as other factors. In some embodiments, the openings are between about 10 and 20 microns with smaller and larger openings also being possible.

The cap 175 can be formed from extruded aluminum with other materials (e.g., plastic, stainless steel, etc.) and other construction methods (e.g., injection molding, forging, casting, etc.) also being possible. In an exemplary embodiment, straight extruded portions can be welded together to define the cap 175.

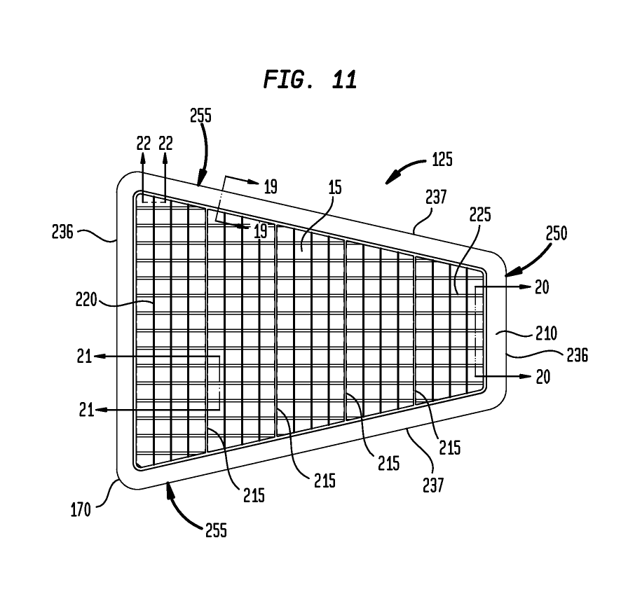

FIG. 11 illustrates another arrangement of a filter panel 125 that includes a one-piece pleated filter media disposed within a frame 210. Embodiments of FIGS. 11 and 19-22 are similar to the construction of FIGS. 9 and 10, but also include reinforced cross bracing 220 and peak stiffening members or ridge bars 225. In general, the ridge bars 225 and the stringers 215 cooperate to subdivide the filter media into a plurality of smaller cells. The cells are sized as will be discussed below. The stringers 215, cross braces 220, and ridge bars 225 are reinforcing members that aid in maintaining the pleated shape of the pleated filter media. Other reinforcing members or arrangements of the reinforcing members described herein which are suitable for maintaining the pleated shape of the filter media may also be used.

FIG. 13 illustrates a possible arrangement of nozzles 200 on a spray bar 190. As previously described, spray bars 190 can be positioned between adjacent discs 30 and at the ends of the disc filter 10 to enable the spraying of high-pressure water in a reverse flow direction through the pleated filter media 15 to provide backwashing of the filter media 15. Because the filter media 15 is pleated and thus angled with respect to the plane of the discs 30, the use of nozzles 200 that are similarly angled provides for more efficient backwash cycles. Thus, the nozzles 200 are angled approximately 45 degrees off of a normal direction to the planes of the discs 30. In addition, two nozzles 200 are provided at each spray point 244 (see FIG. 12) with the nozzles 200 angled with respect to one another at about 90 degrees such that both sides of the pleats are sprayed directly during the backwashing. Surprisingly, a straight on direct spray may be utilized. In addition, bouncing spray off the filter media at an angle improves the cleaning effect and efficiency for a given amount of backwash flow and spray velocity.

As illustrated in FIG. 12, each spray bar 190 may include multiple spray points 244 with four nozzles 200 supported at each spray point 244. FIG. 12 illustrates six spray points 244 are employed with more or fewer points being possible. As the discs 30 rotate, the nozzles 200 direct high-pressure water onto the pleated filter media 15 and clean the filter media 15. The end-most spray bars 190 only require two nozzles 200 per spray point 244 as they are not disposed between two adjacent discs 30.

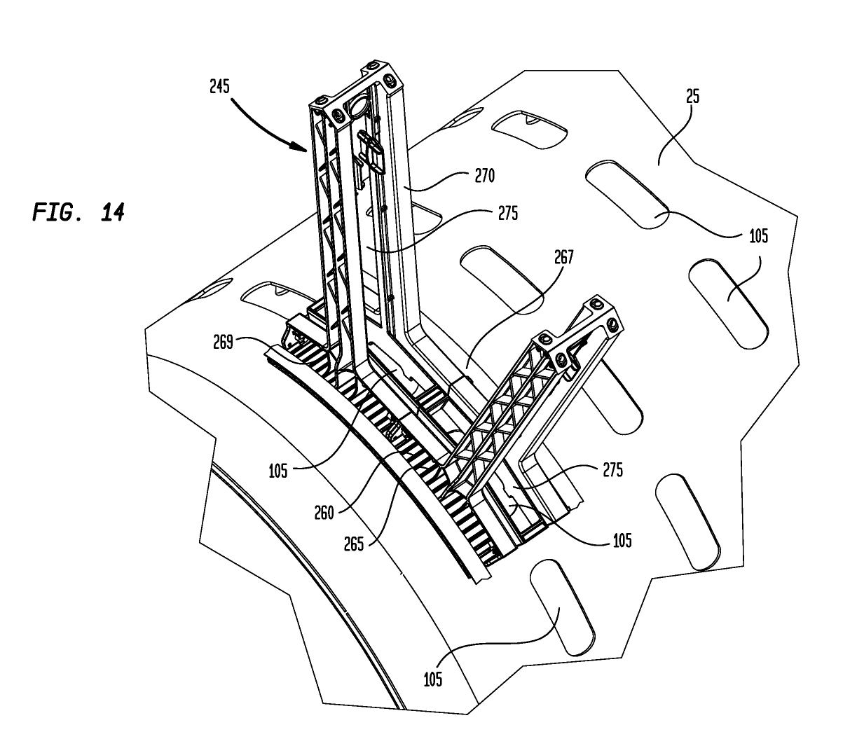

Referring to FIG. 14, a filter support 245 is shown positioned on the drum 25. The filter support serves to support a portion of a side 255 and bottom portion 250 of a pair of filter panels 125 (see FIG. 11). The filter support 245 includes an attachment portion 260 and a transversely oriented strut portion 270. The attachment portion 260 includes a first section 265, which extends from an end 267 of the strut portion 270. The attachment portion 260 also includes a second section 269, which extends from the end 267 in a direction opposite to the first section 265 to thus form an inverted T-shaped filter support 245. The attachment portion 260 further includes a single aperture 275, which extends along the first 265 and second 269 sections of the attachment portion 260 and along the strut portion 270 to thus form a substantially inverted T-shaped aperture which corresponds to the shape of the filter support 245.

The attachment portion 260 is designed to be maintained in alignment with drum aperture 105 such that the aperture 275 is in fluid communication with an associated drum aperture 105 in the drum 25. The aperture 275 is substantially the same size or larger than the drum aperture 105. In an exemplary embodiment, the filter support 245 is positioned on the drum 25 such that the attachment portion 260 straddles a support section of the drum 25 located in between adjacent drum apertures 105. In such an embodiment, portions of two adjacent drum apertures 105 can be in fluid communication with the aperture 275.

Water to be filtered enters a filter panel set 300 through the drum aperture 105 and the aperture 275. The water in the filter panel set 300 is then filtered through the filter panels 125 to provide filtered water. The aperture 275 is of sufficient size relative to the drum aperture 105 such that trash or other debris which may flow through the drum aperture 105 is not captured by the radial strut 270. In one embodiment, the aperture 275 is substantially equal in size to the drum aperture 105. In another embodiment, the aperture 275 is sized larger than the drum aperture 105. As a result, the amount of trash collected by the radial strut 270 is substantially reduced or eliminated, resulting in relatively unimpeded flow of water and air between filter panel sets 300 as the drum 25 rotates. This design can reduce, or minimize, water turbulence from water inertia and prevents air entrapment and subsequent release so that the undesirable wash off of solids already filtered from the water is substantially reduced. The radial strut 270 further includes ribs 305 which provide structural support.

As previously described, the disc filter 10 may use filter panels 125 that are pleated, although other types of panels may be used. One advantage of pleated filter media 15 is that both the media pleats themselves, as well as the panel perimeter sidewalls such as those along the radial sides of the pleated panel 125, provide temporarily horizontal surfaces to which trash can cling more readily. As a result, rotating shelves are formed while submerged which are oriented at a favorable angle with respect to gravity until the trash is over the trough for eventual deposit thereon.

In use, water (third flow 620) can enter the disc filter 10 via the influent pipe 60. The contaminated influent water is separated from the clean filtered water using a wall 76 through which the drum is mounted with a rotating seal. The wall 76 forms an influent water chamber 77 and a filtrate water chamber 75. The influent enters the drum interior 65 and exits through drum apertures 105 in the drum 25 and flows into volume 182. The water in volume 182 is then filtered through the pleated filter media 15 in at least one of the filter panels 125 and flows out (“inside out flow”) to provide filtered water. As the influent passes through the pleated filter media 15, particulates that are larger than the openings in the filter media 15 are retained within volume 182 and remain on an inside surface of the filter media 15. The effluent collects within the filtrate water chamber 75 outside of the discs 30 and exits the disc filter 10 via the effluent pipe 70. A system of weirs defines the effluent end of filtrate water chamber 75 and maintains the desired minimum liquid level in chamber 75 within the filter 10.

The drum 25 continuously or intermittently rotates such that filter panels 125 enter the liquid and filter influent only during a portion of the rotation. As previously described, the aperture 275 enables fluid communication between the drum aperture 105 and adjacent filter panel sets 300. This enables water and air to flow circumferentially between adjacent filter panel sets 300 as the drum 25 rotates. As a result, the amount of trash collected by the radial strut 270 is substantially reduced or eliminated, resulting in relatively unimpeded flow of water and air between filter panel sets 300 as the drum 25 rotates. This design feature minimizes water turbulence from water inertia and prevents air entrapment and subsequent release so that the undesirable wash off of solids already filtered from the water is substantially reduced.

Because the discs 30 are never fully submerged, filter panels 125 enter the liquid and are available for filtering influent only during the bottom portion of the rotation arc. After filtering, and during rotation of drum 25, the filter panels 125 exit the liquid and pass the spray bars 190. During a backwash cycle, the spray device 85 can be used to spray the filter panels 125 with high-pressure water or chemicals to dislodge the particulates and clean the filter media 15 as the drum 25 rotates. The water droplet impact vibration and penetration of the filter media 15 by a portion of the water removes debris that is caught on the upstream surface of the pleated filter media 15. The debris and water are collected in the trough 205 and transported out of the filter system 10 by pipe 90. During backwashing, filtration can continue as some of the filter panels 125 are disposed within the liquid, while others are above the liquid and can be backwashed

The filter panels 125 can provide for a greater flow area than conventional systems and are capable of operating at a substantially higher flow through a similar panel area. The perimeter frame 210 defines a panel normal flow area 350, shown in FIG. 9, which is essentially the planar area within the perimeter frame 210. The true flow area can be less than this planar area as support members may extend across this area and block some of the flow area. But this area is minimal and generally can be ignored. By forming pleats in the filter media, the flow area increases as the fluid (e.g., air, water) flows generally through the pleats in a direction 365 normal to the pleat, as illustrated in FIG. 10. Thus, the pleats define a media normal flow area 360 that is substantially greater than the panel normal flow area 350. Essentially, the media normal flow area 360 is the sum of the areas of the various pleats measured in a plane normal to the flow direction 365. In an exemplary embodiment, the media normal flow area 360 for each filter panel 125 is greater than about one square foot (approximately 0.09 square meters) with sizes greater than about two square feet (approximately 0.19 sq meters) being preferred. Test data shows that this flow area provides for a flow rate through each filter panel in excess of about seven gallons per minute (approximately 26.5 liters per minute). More specifically, each filter panel 125 is configured to pass a liquid flow therethrough. The liquid flow is in excess of about three gallons per minute per square foot (approximately 11.4 liters per minute per 0.09 sq. feet) and is at a pressure differential across the filter media in excess of about 12 inches of water (approximately 3 kPa).

The low end pleat height is based on a micropleat design with thin panels having many tiny pleats, while the high end design is based on a thick panel design. In addition, the low end included angle is possible due to the unexpected finding that solids can be easily removed from the valleys, and that the risk of being unable to clean the valleys was very low. The velocity past the cleaning nozzles is at least partially a function of the size of the discs with smaller discs allowing for higher angular velocities.

In operation, the multi-stage treatment system 400 of FIG. 1 receives the flow of influent 415 containing contaminants, including for example phosphorus. The flow of influent 415 is treated to achieve a desired pH and alkalinity. In addition, a quantity of polymer 425 and coagulant 430 is added to produce a first flow 440. The first flow 440 enters the first section 445 of the multi-stage treatment system 400, where the polymer 425 functions to produce large clumps of contaminates or floc, and the coagulant 430 precipitates a portion of the phosphorus. The precipitate and flow collect to form the sludge 455 which is pumped to waste 480. In one arrangement, a portion of the sludge 455 is pumped to the influent 415 or first flow 440 before the first flow 440 enters the first section 445. In an exemplary embodiment, approximately one to five percent of the sludge 455 can be recirculated. As discussed, coagulant 490 may be added to the recirculated flow of sludge 455 if desired, to further reduce the phosphorus content of the fluid in the system 400.

The flow exits the first section 445 as the second flow 450 and passes to the second section 495 of the multi-stage treatment system 10. During the transit between the first section 445 and the second section 495, additional coagulant 600 and polymer 605 may be added, as desired.

The second flow 450 passes through the second section 495 where additional contaminates, including additional phosphorus can be removed from the flow 450. The third flow 620 leaves the second section 495 and enters the third section 645 of the multi-stage treatment system 400. During the transit from the second section 495 to the third section 645, additional coagulant 650 may be added to the third flow 620 to further reduce the quantity of phosphorus or other contaminants within the flow 620.

The third flow 620 passes through the third section 645 of the multi-stage treatment system 400 and exits the multi-stage treatment system 400 as the effluent 420.

As illustrated in FIG. 2, the second section 495 is periodically rinsed and the third section 645 is periodically backwashed to remove a significant portion of the contaminates collected by the two sections 495, 645 of the multi-stage treatment system 10. The contaminates are collected from the respective sections 495, 645 and are directed to waste 480. A portion of the contaminates 635, 680 from each of the respective stages can be redirected to the influent 415 or the first flow 440 prior to the first flow's entry into the first section 445. Additional coagulant 640, 685 can be added to one or both of the redirected flow of contaminates 635, 680 as desired.

In an exemplary embodiment, backwashing of the disc filter can use filtered water that can be housed in a buffer tank. A pump can be in communication or carried by the buffer tank. This pump is adapted to pull water from the buffer tank and direct it to the spray nozzles situated on the sides of the disc. A backwash supply external to the buffer tank is not necessary as part of the standard design, although an alternate backwash supply line can be incorporated into the design to supplement the buffer tank water supply. Captured solids are removed from the disk panels by the spray nozzles and the waste is directed to a waste collection trough internal to the disk housing. A separate pipe connects the trough to the waste discharge point.

In an exemplary embodiment, additional coagulant can be added between the first stage and second stage (100), or to the sludge 485 being pumped back to the influent 415 of the first flow 440 (90).

In an exemplary embodiment, a control system monitors the level of phosphorus, as well as other contaminate levels, throughout the treatment process to determine where to add additional coagulant and in what quantity that must be added to achieve the desired level of contaminants, e.g., phosphorus in the effluent 20, while using the least amount of coagulant possible. In one arrangement, the multi-stage treatment system 10 reduces the level of phosphorus below about 10 ppb.

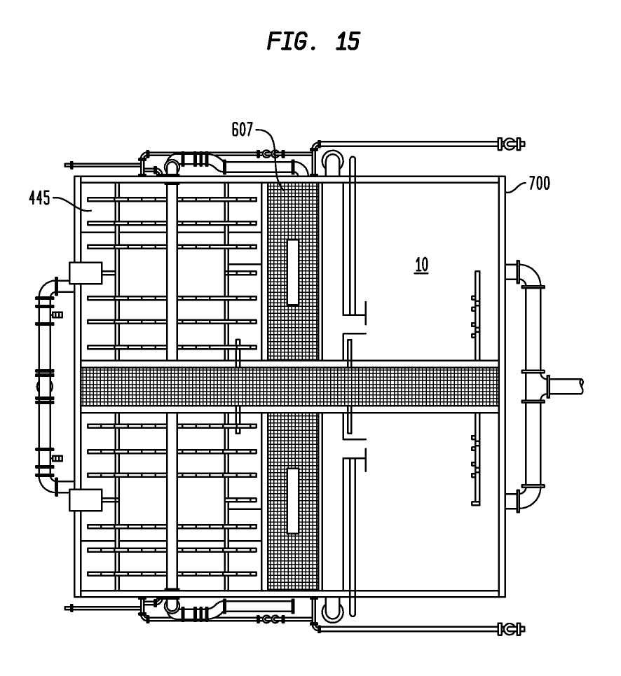

Referring now to FIG. 15, a top view of the tube clarifier 445, adsorption clarifier 607 and disc filter 10 is shown. The tube clarifier 445, adsorption clarifier 607 and disc filter 10 are located in a tank 700, thus enabling the integration of the two unit processes (two stage clarification and disc filtration) into a common tank. The disc filter is located in a buffer tank section. Filtered water is collected in the buffer tank section of the unit prior to it passing over an effluent weir and discharging from the unit. The filtered water stored in the buffer section is used to periodically clean the retained particles from the disc membrane surface. A pump system that is part of the disc filter assembly draws water from the buffer tank section and redirects it backward through the disc membrane to dislodge and remove the captured solids. A piping system conveys the washed out solids to a waste sump. FIG. 15 depicts a two tank system.

Embodiments of the present invention can substantially reduce or eliminate the need for a separate backwash storage tank such as that used in configurations which utilize a granular media filter. This can reduce construction costs and time, the amount of downtime during the filter cleaning process, the plant footprint and installation time as compared to a granular media filter configuration. In addition, the hydraulic grade line of the system is reduced since the disc filter operates on a lower headloss than a media filter.

Automated operational control of the system may be conducted by a single programmable controller that oversees the treated water quality monitoring, cleaning functions and chemical dosing system during operation of the unit(s).

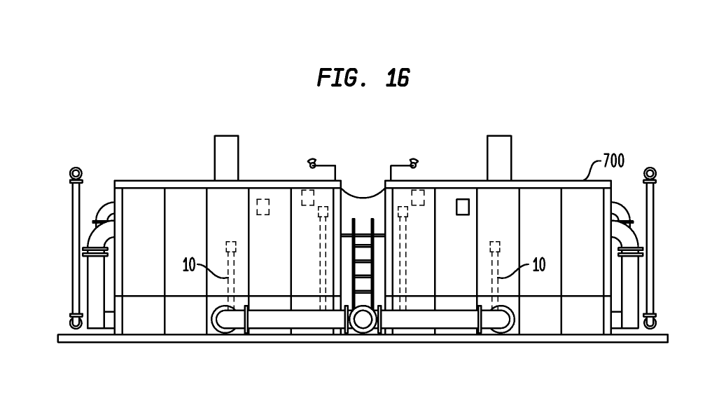

Referring to FIG. 16, a side view of the tank 700 is shown. The location of the disc filter is currently shown as the minimum elevation and the assembly could be moved upward in the buffer tank to increase filtered water storage and minimize the hydraulic profile drop across the unit. In this embodiment, the top of the disc filter can be above the top of the tank which would not be detrimental to the design or operation.

In some embodiments, a UV disinfection system may be located in the open space of the disc filter effluent water compartment. The UV system can require increasing the minimum water level in the buffer tank from the current elevation shown.

While embodiments of the present invention are shown using a factory fabricated tank (maximum current design is about two million gallons per day in a single treatment train) to contain the unit process equipment for larger scale systems (over about five million gallons per day in a single treatment train) a concrete tank design can be used to provide the same treatment process and unified process control.

Embodiments of the invention may be applied to secondary clarified wastewater or surface water source (river, lake, spring, and the like) with physical-chemical treatment using coagulant addition to remove suspended contaminants and targeted dissolved contaminants (such as phosphorus, color, and total organic carbon) from the water supply. The quality of water produced would be sufficient for many direct water reuse applications, pretreatment for higher quality reuse applications and for industrial process water supplies. A single treatment train or multiple trains running in parallel with one another could be used.

While exemplary embodiments of the invention have been disclosed many modifications, additions, and deletions can be made therein without departing from the spirit and scope of the invention and its equivalents, as set forth in the following claims.

What is claimed is:

1. A system for removing at least one contaminant from an influent, the system comprising:
a first section comprising a tube section, the first section receiving the influent, dividing the influent into a first flow and a sludge, and discharging the first flow;
a first coagulant inlet positioned upstream of the first section and in fluid communication with the influent to introduce a first coagulant for precipitating the contaminant;
a second section comprising an adsorption clarifier, the second section receiving the first flow and discharging a second flow;
a third section comprising a disc filter, the third section receiving the second flow and discharging an effluent;
a second coagulant inlet positioned downstream of the first section and upstream of the third section to introduce a second coagulant for precipitating the contaminant;
a first return line connecting the sludge to a position upstream of, and in fluid communication with, the first section, wherein a portion of the sludge is pumped via the first return line to a position upstream of the first section, and wherein a portion of the sludge is mixed with the influent; and
at least one additional return line connecting a position downstream of the first section, to a position upstream of, and in fluid communication with, the first section, wherein a portion of contaminates from the position downstream of the first section is pumped via the additional return line to a position upstream of the first section, and wherein a portion of the contaminates is mixed with the influent, wherein a third coagulant is introduced into the first return line before the portion of sludge is mixed with the influent.

2. The system of claim 1, wherein the influent enters the first section below the tube section and the first flow exits the first section above the tube section.

3. The system of claim 1, wherein the first coagulant and the second coagulant are at least one metal salt.

4. The system of claim 3, wherein the at least one metal salt is chosen from alum, ferric chloride, and ferric sulfate.

5. The system of claim 1, wherein the second coagulant inlet is positioned to introduce the second coagulant to the first flow.

6. The system of claim 1, wherein the second coagulant inlet is positioned to introduce the second coagulant to the second flow.

7. The system of claim 1, wherein the second coagulant inlet is positioned to introduce the second coagulant to the media filter during a backwash cycle.

8. The system of claim 1, wherein the tube section comprises inclined tubes.

9. The system of claim 1, wherein the at least one additional return line is downstream of the second section.

10. The system of claim 1, wherein the at least one additional return line is downstream of the third section.

11. The system of claim 1, wherein the tube section and the adsorption clarifier are arranged in a stacked configuration.

12. The system of claim 1, wherein the tube section and the adsorption clarifier are arranged in a side-by-side configuration.

13. The system of claim 1, wherein the contaminant is phosphorus.

14. A system for removing a contaminant from an influent, the system comprising:
a tube assembly adapted to receive the influent, divide the influent into a first flow and a sludge, and discharge the first flow;
a first coagulant inlet positioned upstream of the tube assembly and in fluid communication with the influent to introduce a first coagulant adapted to precipitate the contaminant;
an adsorption clarifier assembly adapted to receive the first flow and discharge a second flow;
a disc filter assembly adapted to receive the second flow and discharge an effluent;
a second coagulant inlet positioned downstream of the tube assembly and upstream of the disc filter assembly to introduce a second coagulant to precipitate the contaminant;
a first return line connecting the sludge to a position upstream of, and in fluid communication with, the tube assembly, wherein a portion of the sludge is pumped via the first return line to a position upstream of the tube assembly, and wherein a portion of the sludge is mixed with the influent; and
at least one additional return line connecting a position downstream of the tube assembly, to a position upstream of, and in fluid communication with, the tube assembly, wherein a portion of contaminates from the position downstream of the tube assembly is pumped via the additional return line to a position upstream of the tube assembly, wherein a portion of the contaminates is mixed with the influent, and wherein a third coagulant is introduced into the first return line before the portion of sludge is mixed with the influent.
